(19) United States
(12) Patent Application Publication
(10) Pub. No.: US 2016/0171963 A1
(43) Pub. Date: Jun. 16, 2016

(54) METHOD, SYSTEM AND COMPUTER-READABLE RECORDING MEDIUM FOR REMOVING ACTIVE NOISE OF CAR

(71) Applicant: HYUNDAI MOTOR COMPANY, Seoul (KR)

(72) Inventors: Chang Hee CHO, Dalseo-gu (KR); Un Hwan SOL, Yongin-si (KR)

(21) Appl. No.: 14/704,928

(22) Filed: May 5, 2015

(30) Foreign Application Priority Data
Dec. 11, 2014 (KR) 10-2014-0178285

(51) Int. Cl. G10K 11/175

(52) U.S. Cl. CPC G10K 11/175; G10K 2210/1282

(57) ABSTRACT

An active noise removal system includes smart glasses for transmitting sampled ambient noise via a Bluetooth hands-free streaming channel to a head unit, and the head unit for outputting sound by offsetting noise using the received ambient noise through output feedback of a phase wave. Since ambient noise may be safely transmitted via a Bluetooth hands-free streaming channel connected between smart glasses and a head unit, the head unit may offset noise very accurately and thus sound effects may be maximized.

### CROSS-REFERENCE TO RELATED APPLICATION

This application claims the benefit of Korean Patent Application No. 10-2014-0178285, filed on Dec. 11, 2014 with the Korean Intellectual Property Office, the disclosure of which is hereby incorporated by reference as if fully set forth herein.

### BACKGROUND OF THE INVENTION

1. Field of the Invention

The present invention relates to a method, system and computer-readable recording medium for removing active noise, and more particularly, to a method, system and computer-readable recording medium for removing sound-related active noise of a car.

2. Discussion of the Related Art

In a general active noise removal (cancellation) scheme of a car, ambient noise inside the car is acquired using, for example, a microphone installed in the car, and the car noise is offset (cancelled) by adjusting the phase for sound output.

However, since the microphone is spaced apart from the head of a driver by about 30 to 50 cm and the ambient noise is mostly located in the lower register, due to the characteristics of long-wavelength sound, accurate matching with a sound resonance point at 95% eyellipse head position is not easy.

As such, the location of a noise acquisition part is critical to generate a phase wave for accurate and efficient noise removal, but a microphone is not easily located near a driver's head when the driver is seated due to the characteristics of a car.

For example, since a car microphone is installed on a headlining or an overhead console, noise near the microphone rather than the head of the driver is mainly removed (cancelled) and thus efficiency of acoustic noise cancellation for the driver is reduced.

### RELATED ART DOCUMENT

### Patent Document

(Patent document 1) 1. KR Publication No. 2009-0050372, Publication date: May 20, 2009, Title of the Invention: Noise cancelling method and apparatus from the mixed sound.

(Patent document 2) 2. KR Publication No. 2006-0135924, Publication date: Dec. 29, 2006, Title of the Invention: Glasses frame comprising an integrated acoustic communication system for communication with a mobile radio appliance, and corresponding method.

### SUMMARY OF THE INVENTION

Accordingly, the present invention is directed to a method, system and computer-readable recording medium for removing active noise which substantially obviate one or more problems due to limitations and disadvantages of the related art.

An object of the present invention is to provide a method, system and computer-readable recording medium for removing active noise by acquiring ambient noise using a microphone included in smart glasses which may be worn by a driver and offsetting the ambient noise in a head unit.

Additional advantages, objects, and features of the invention will be set forth in part in the description which follows and in part will become apparent to those having ordinary skill in the art upon examination of the following or may be learned from practice of the invention. The objectives and other advantages of the invention may be realized and attained by the structure particularly pointed out in the written description and claims hereof as well as the appended drawings.

To achieve these objects and other advantages and in accordance with the purpose of the invention, as embodied and broadly described herein, an active noise removal system includes smart glasses for transmitting sampled ambient noise via a Bluetooth hands-free streaming channel to a head unit, and the head unit for outputting sound by offsetting noise using the received ambient noise through output feedback of a phase wave.

The smart glasses may receive a noise request signal from the head unit and periodically acquire the ambient noise based on the noise request signal.

The smart glasses may store the acquired ambient noise in a memory, and the memory may be a buffer.

The smart glasses may include a microphone sampling sample and outputting the ambient noise stored in the memory.

The smart glasses may open the streaming channel connected to the head unit, and then transmit the sampled ambient noise output from the microphone, via the open streaming channel to the head unit.

The smart glasses may switch the streaming channel to a standby mode after the ambient noise is transmitted to the head unit.

In another aspect of the present invention, a noise removal method of an active noise removal system includes steps of (a) transmitting sampled ambient noise via a Bluetooth hands-free streaming channel from smart glasses to a head unit, and (b) outputting sound from the head unit and offsetting noise using the received ambient noise through output feedback of a phase wave.

The step (a) may further include a step (a-1) of receiving a noise request signal from the head unit and periodically acquiring the sampled ambient noise based on the noise request signal by the smart glasses.

The step (a) may further include a step (a-2) of storing the sampled acquired ambient noise in a memory. In this case, the memory may be a buffer.

The step (a) may further include a step (a-3) of sampling and outputting the ambient noise stored in the memory, through a microphone.

The step (a) may further include a step (a-4) of opening the streaming channel connected to the head unit, and then transmitting the ambient noise stored in the memory, via the open streaming channel to the head unit.

The step (a) may further include a step (a-5) of switching the streaming channel to a standby mode after the ambient noise is transmitted from the smart glasses to the head unit.

In another aspect of the present invention, smart glasses of an active noise removal system include a noise request reception unit for receiving a noise request signal from a head unit, an ambient noise acquisition unit for periodically acquiring ambient noise based on the noise request signal, a sampling control unit for storing the acquired ambient noise, and sampling and outputting the stored ambient noise, and an ambient noise transmission unit for transmitting the ambient noise sampled by the sampling control unit, via an open Bluetooth hands-free streaming channel to the head unit to allow the ambient noise to be used to offset noise through output feedback of a phase wave.

In another aspect of the present invention, a noise removal method of smart glasses includes (a) receiving a noise request signal from a head unit by a noise request reception unit, (b) periodically acquiring ambient noise based on the noise request signal by an ambient noise acquisition unit, (c) storing the acquired ambient noise, and sampling and outputting the stored ambient noise by a sampling control unit, and (d) transmitting the sampled ambient noise via an open Bluetooth hands-free streaming channel from an ambient noise transmission unit to the head unit to allow the ambient noise to offset noise through output feedback of a phase wave.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiment(s) of the invention and together with the description serve to explain the principle of the invention. In the drawings:

FIG. 1 is a block diagram of an active noise removal system according to Embodiment 1 of the present invention;

FIG. 2 is a diagram showing the flow of messages processed by the active noise removal system according to Embodiment 1 of the present invention;

FIG. 3 is a flowchart of a noise removal method of the active noise removal system according to Embodiment 2 of the present invention;

FIG. 4 is a detailed flowchart of the noise removal method of the active noise removal system according to Embodiment 2 of the present invention;

FIG. 5 is a block diagram of smart glasses of the active noise removal system according to Embodiment 3 of the present invention; and

FIG. 6 is a flowchart of a noise removal method of the smart glasses according to Embodiment 4 of the present invention.

### DETAILED DESCRIPTION OF THE INVENTION

Reference will now be made in detail to the preferred embodiments of the present invention, examples of which are illustrated in the accompanying drawings. Wherever possible, the same reference numbers will be used throughout the drawings to refer to the same or like parts.

### Embodiment 1

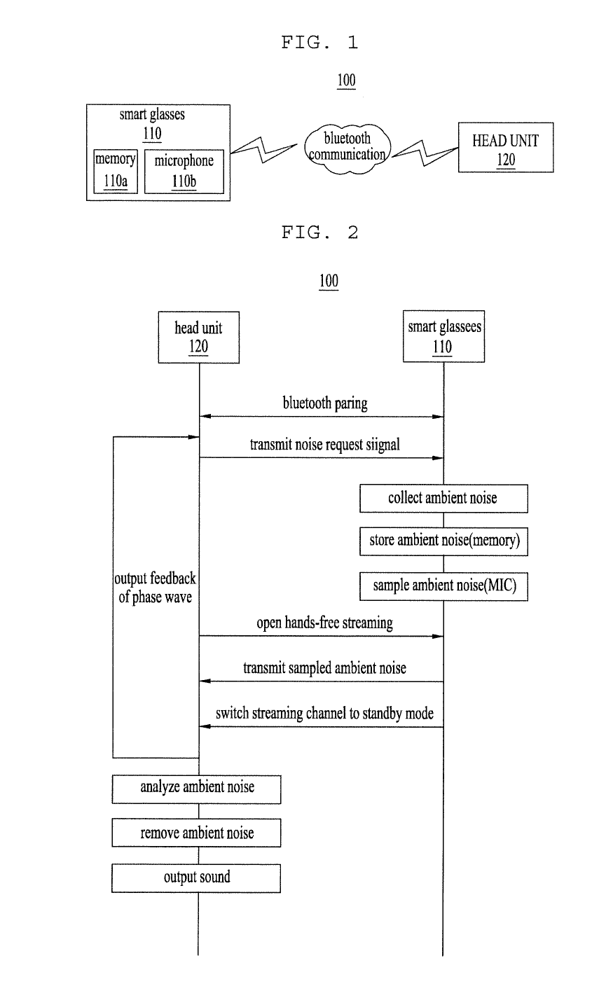

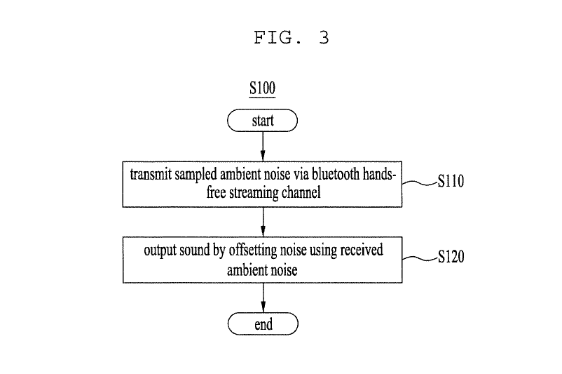

FIG. 1 is a block diagram of an active noise removal system 100 according to Embodiment 1 of the present invention, and FIG. 2 is a diagram showing the flow of messages processed by the active noise removal system 100 according to Embodiment 1 of the present invention.

As illustrated in FIGS. 1 and 2, the active noise removal system 100 according to Embodiment 1 of the present invention includes smart glasses 110 and a head unit 120.

According to the present invention, the smart glasses 110 initially are paired and perform Bluetooth communication with the head unit 120. When Bluetooth communication between the smart glasses 110 and the heat unit 120 is established, a hands-free function may be performed between the smart glasses 110 and the head unit 120.

In this case, data for the hands-free function may be transmitted and received via a hands-free streaming channel connected through Bluetooth communication. This hands-free streaming channel may be used to transmit ambient noise acquired by the smart glasses 110 to the heat unit 120.

To this end, the smart glasses 110 according to the present invention initially receive a noise request signal from the head unit 120 and periodically acquire ambient noise based on the received noise request signal. In this case, the acquired ambient noise may be stored in a memory 110a of the smart glasses 110.

At this time, the memory 110a may be a volatile memory or a non-volatile memory, and is preferably a buffer. If the ambient noise is stored in the memory 110a as described above, the smart glasses 110 according to the present invention may transmit the ambient noise stored in the memory 110a to a microphone 110b based on the noise request signal of the head unit 120.

Accordingly, if the ambient noise passes through the microphone 110b, the ambient noise passing through the microphone 110b is sampled. This sampled ambient noise may be transmitted to the head unit 120.

Preferably, when the streaming channel between the smart glasses 110 and the head unit 120 is open, the sampled ambient noise is transmitted via the open streaming channel to the head unit 120.

That is, the smart glasses 110 according to the present invention may transmit the sampled ambient noise output from the microphone 110b, via the streaming channel to the head unit 120 after the streaming channel between the smart glasses 110 and the head unit 120 is open.

As described above, in the current embodiment, since the buffer is used, the streaming channel may not need to be open during a certain noise acquisition time and the ambient noise may be transmitted using the streaming channel after the noise acquisition time, thereby minimizing system resource maintenance.

After the sampled ambient noise is transmitted via the open streaming channel, the smart glasses 110 according to the present invention switch the streaming channel connected to the head unit 120, to a standby mode.

Alternatively, the streaming channel may be switched to the standby mode by the head unit 120. If the streaming channel is switched to the standby mode, system resource maintenance may be optimized. In this case, the standby mode refers to an off state of the streaming channel.

After the sampled ambient noise is transmitted, the head unit 120 according to the present invention periodically samples the ambient noise received from the smart glasses 110, through output feedback of a phase wave. The head unit 120 may remove (offset) the ambient noise, the phase wave of which is output fed back, through analysis.

The above noise removal scheme achieves low influence between a head position and a resonance point due to a wavelength range at 100 Hz (λ=3.4 m), 500 Hz (λ=0.68 m), 1 kHz (2=0.34 m), and frequencies above about 2 to 3 kHz, e.g., 2 kHz (λ=0.17 m), but allows output of high-quality sound at frequencies lower than the above-mentioned frequencies by sufficiently solving difficulties in optimal matching between the resonance point and the head position due to long wavelengths.

### Embodiment 2

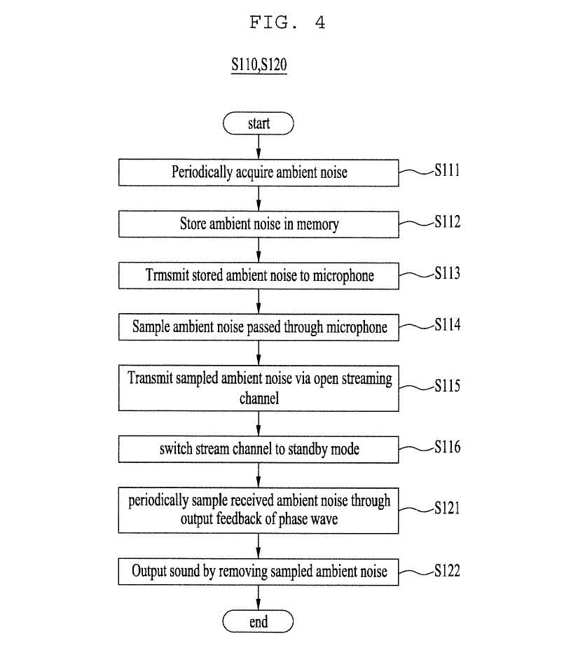

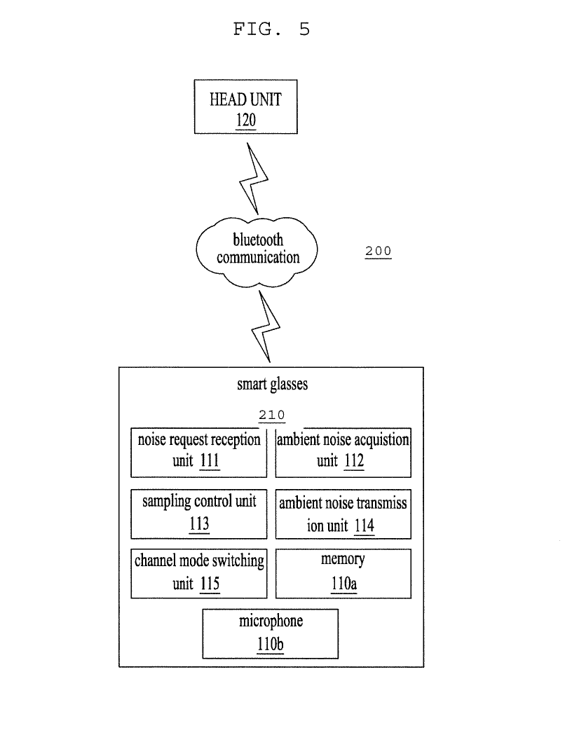

FIG. 3 is a flowchart of a noise removal method S100 of the active noise removal system 100 according to Embodiment 2 of the present invention, and FIG. 4 is a detailed flowchart of the noise removal method S100 of the active noise removal system 100 according to Embodiment 2 of the present invention.

Referring to FIG. 3, the noise removal method S100 of the active noise removal system 100 according to Embodiment 2 of the present invention, may include step S110 for sampling ambient noise and then transmitting the sampled ambient noise to the head unit 120 by the smart glasses 110, and step S120 for offsetting the sampled ambient noise and outputting sound by the head unit 120 based on the received sampled ambient noise.

A detailed description is now given of each step with reference to FIG. 4. Referring to FIG. 4, initially, in step 9110 according to the present invention, the smart glasses 110 receive a noise request signal from the head unit 120 and then periodically acquire ambient noise based on the received noise request signal (9111).

Then, in step S110 according to the present invention, the ambient noise acquired in step S111 is stored in the memory 110a of the smart glasses 110 (S112). At this time, the memory 110a for storing the ambient noise may be a volatile memory or a non-volatile memory, and is preferably a buffer.

If the ambient noise is stored in the memory 110a as described above, in step 9110 according to the present invention, the ambient noise stored in the memory 110a is transmitted to the microphone 110b of the smart glasses 110 based on the noise request signal of the head unit 120 (S113).

Then, in step 9110 according to the present invention, if the ambient noise passes through the microphone 110b, the ambient noise passing through the microphone 110b is sampled (S114). This sampled ambient noise may be transmitted to the head unit 120.

Preferably, when a streaming channel between the smart glasses 110 and the head unit 120 is open, the sampled ambient noise is transmitted via the open streaming channel from the smart glasses 110 to the head unit 120 (S115).

As described above, in the current embodiment, since the buffer is used, the streaming channel may not need to be open during a certain noise acquisition time and the ambient noise may be transmitted using the streaming channel after the noise acquisition time, thereby minimizing system resource maintenance.

Then, in step S110 according to the present invention, after the sampled ambient noise is transmitted via the open streaming channel, the streaming channel is switched to a standby mode (S116). The streaming channel may be switched to the standby mode by the head unit 120 or the smart glasses 110.

If the streaming channel is switched to the standby mode as described above, system resource maintenance may be optimized. In this case, the standby mode refers to an off state of the streaming channel.

After the sampled ambient noise is transmitted, in step S120 according to the present invention, the head unit 120 periodically samples the ambient noise received from the smart glasses 110, through output feedback of a phase wave (S121).

Then, the head unit 120 outputs sound by removing the ambient noise, which is sampled in step S121, through analysis (S122). In this case, the ambient noise may be removed using a commonly known noise removal method.

The above noise removal scheme achieves low influence between a head position and a resonance point due to a wavelength range at 100 Hz (λ=3.4 m), 500 Hz (λ=0.68 m), 1 kHz (λ=0.34 m), and frequencies above about 2 to 3 kHz, e.g., 2 kHz (λ=0.17 m), but allows output of high-quality sound at frequencies lower than the above-mentioned frequencies by sufficiently solving difficulties in optimal matching between the resonance point and the head position due to long wavelengths.

### Embodiment 3

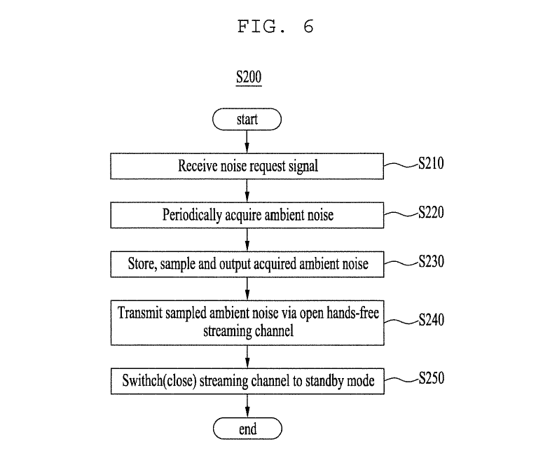

FIG. 5 is a block diagram of smart glasses 210 of an active noise removal system 200 according to Embodiment 3 of the present invention.

Referring to FIG. 5, the smart glasses 210 of the active noise removal system 200 according to Embodiment 3 of the present invention further includes a noise request reception unit 111, an ambient noise acquisition unit 112, a sampling control unit 113, an ambient noise transmission unit 114 and a channel mode switching unit 115 to remove noise from sound of a car.

Initially, when the smart glasses 210 and the head unit 120 are paired through Bluetooth communication, the noise request reception unit 111 according to the present invention receives a noise request signal from the head unit 120.

Then, the ambient noise acquisition unit 112 according to the present invention periodically acquires ambient noise based on the noise request signal received by the noise request reception unit 111.

Then, the sampling control unit 113 according to the present invention stores the ambient noise acquired by the ambient noise acquisition unit 112, in the memory 110a, and samples and outputs the ambient noise stored in the memory 110a, through the microphone 110b.

In this case, the memory 110a may be a volatile memory or a non-volatile memory, and is preferably a buffer. Since the buffer is used as described above, a streaming channel may not need to be open during a certain noise acquisition time.

Then, the ambient noise transmission unit 114 according to the present invention transmits the ambient noise sampled by the sampling control unit 113, via a Bluetooth hands-free streaming channel to the head unit 120.

In this case, the Bluetooth hands-free streaming channel is preferably open to transmit the sampled ambient noise to the head unit 120. Since the ambient noise is transmitted using the streaming channel after the certain noise acquisition time as described above, system resource maintenance may be minimized.

Then, the channel mode switching unit 115 according to the present invention switches the open streaming channel to a standby mode after the sampled ambient noise is transmitted via the streaming channel to the head unit 120. If the open streaming channel is switched back to the standby mode as described above, system resource maintenance may be optimized.

As such, the head unit 120 may periodically sample the ambient noise received from the smart glasses 210, through output feedback of a phase wave, and then remove (offset) noise through noise analysis.

The above noise removal scheme achieves low influence between a head position and a resonance point due to a wavelength range at 100 Hz (λ=3.4 m), 500 Hz (λ=0.68 m), 1 kHz (λ=0.34 m), and frequencies above about 2 to 3 kHz, e.g., 2 kHz (λ=0.17 m), but allows output of high-quality sound at frequencies lower than the above-mentioned frequencies by sufficiently solving difficulties in optimal matching between the resonance point and the head position due to long wavelengths.

### Embodiment 4

FIG. 6 is a flowchart of a noise removal method S200 of the smart glasses 210 according to Embodiment 4 of the present invention.

Referring to FIG. 6, the noise removal method S200 of the smart glasses 210 according to Embodiment 4 of the present invention includes steps S210 to S250 to remove ambient noise from sound of a car.

Initially, in step S210 according to the present invention, when the smart glasses 210 and the head unit 120 are paired through Bluetooth communication, the noise request reception unit 111 receives a noise request signal from the head unit 120.

Then, in step S220 according to the present invention, the ambient noise acquisition unit 112 periodically acquires ambient noise based on the noise request signal received in step S210.

Then, in step S230 according to the present invention, the sampling control unit 113 may provide control to store the ambient noise acquired in step S220, in the memory 110a, and to sample and output the ambient noise stored in the memory 110a, through the microphone 110b.

In this case, the memory 110a may be a volatile memory or a non-volatile memory, and is preferably a buffer. Since a buffer is used as described above, a streaming channel may not need to be open during a certain noise acquisition time.

Then, in step S240 according to the present invention, the ambient noise transmission unit 114 transmits the ambient noise sampled in step S230, via a Bluetooth hands-free streaming channel to the head unit 120.

In this case, the Bluetooth hands-free streaming channel is preferably open to transmit the sampled ambient noise to the head unit 120. Since the ambient noise is transmitted using the streaming channel after the certain noise acquisition time as described above, system resource maintenance may be minimized.

Then, in step S250 according to the present invention, the channel mode switching unit 115 switches the open streaming channel to a standby mode after the sampled ambient noise is transmitted via the streaming channel to the head unit 120. If the open streaming channel is switched back to the standby mode as described above, system resource maintenance may be optimized.

If the ambient noise is completely transmitted as described above, the head unit 120 having received the ambient noise may periodically sample the ambient noise received from the smart glasses 210, through output feedback of a phase wave, and then remove (offset) noise through noise analysis.

The above noise removal scheme achieves low influence between a head position and a resonance point due to a wavelength range at 100 Hz (λ=3.4 m), 500 Hz (λ=0.68 m), 1 kHz (λ=0.34 m), and frequencies above about 2 to 3 kHz, e.g., 2 kHz (λ=0.17 m), but allows output of high-quality sound at frequencies lower than the above-mentioned frequencies by sufficiently solving difficulties in optimal matching between the resonance point and the head position due to long wavelengths.

The above-described present invention may be implemented with at least one processor and includes a computer-readable medium including program instructions for executing various operations realized by a computer. The computer-readable medium may include program instructions, a data file, and a data structure, separately or cooperatively. The program instructions and the media may be those specially designed and constructed for the purposes of the present invention, or they may be of the kind well known and available to one of ordinary skill in the art of computer software. Examples of the computer-readable media include magnetic media (e.g., hard disks, floppy disks, and magnetic tapes), optical media (e.g., CD-ROMs or DVD), magneto-optical media (e.g., floptical disks), and hardware devices (e.g., ROMs, RAMs, or flash memories, etc.) that are specially configured to store and perform program instructions. Examples of the program instructions include both machine code, such as produced by a compiler, and files containing high-level languages code that may be executed by the computer using an interpreter. The hardware device can be configured to operate as one or more software modules to execute processes according to the present invention, or vice versa.

As is apparent from the above description, according to the present invention, since ambient noise may be safely transmitted via a Bluetooth hands-free streaming channel connected between smart glasses which may be worn by a driver and a head unit, the head unit may offset noise very accurately and thus sound effects may be maximized.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. An active noise removal system comprising:
a head unit; and
smart glasses transmitting sampled ambient noise via a Bluetooth hands-free streaming channel to the head unit,
wherein the head unit outputs sound and offsets noise based on the received ambient noise through output feedback of a phase wave.

2. The active noise removal system according to claim 1, wherein the smart glasses receive a noise request signal from the head unit and periodically acquire the ambient noise based on the received noise request signal.

3. The active noise removal system according to claim 2, wherein the smart glasses store the acquired ambient noise in a memory of the smart glasses.

4. The active noise removal system according to claim 3, wherein the memory is a buffer.

5. The active noise removal system according to claim 3, wherein the smart glasses including a microphone sampling and outputting the ambient noise stored in the memory.

6. The active noise removal system according to claim 5, wherein the smart glasses open the streaming channel connected to the head unit, and transmit the sampled ambient noise output from the microphone, via the open streaming channel to the head unit.

7. The active noise removal system according to claim 6, wherein the smart glasses switch the streaming channel to a standby mode after the ambient noise is transmitted to the head unit.

8. A noise removal method of an active noise removal system, the method comprising steps of:
(a) transmitting sampled ambient noise via a Bluetooth hands-free streaming channel from smart glasses to a head unit; and
(b) outputting sound from the head unit and offsetting noise based on the received ambient noise through output feedback of a phase wave.

9. The noise removal method according to claim 8, wherein the step (a) further comprises a step (a-1) of receiving a noise request signal from the head unit and periodically acquiring the sampled ambient noise based on the noise request signal by the smart glasses.

10. The noise removal method according to claim 9, wherein the step (a) further comprises a step (a-2) of storing the sampled acquired ambient noise in a memory.

11. The noise removal method according to claim 10, wherein a buffer is used as the memory.

12. The noise removal method according to claim 10, wherein the step (a) further comprises a step (a-3) of sampling and outputting the ambient noise stored in the memory, through a microphone.

13. The noise removal method according to claim 12, wherein the step (a) further comprises a step (a-4) of opening the streaming channel connected to the head unit, and then transmitting the ambient noise stored in the memory, via the open streaming channel to the head unit.

14. The noise removal method according to claim 13, wherein the step (a) further comprises a step (a-5) of switching the streaming channel to a standby mode after the ambient noise is transmitted from the smart glasses to the head unit.

15. A computer-readable recording medium having recorded thereon a computer program for executing the noise removal method according to claim 8.

16. Smart glasses of an active noise removal system, the smart glasses comprising:
a noise request reception unit for receiving a noise request signal from a head unit;
an ambient noise acquisition unit for periodically acquiring ambient noise based on the noise request signal;
a sampling control unit for storing the acquired ambient noise, and sampling and outputting the stored ambient noise; and
an ambient noise transmission unit for transmitting the ambient noise sampled by the sampling control unit, via an open Bluetooth hands-free streaming channel to the head unit to allow the ambient noise to be used to offset noise through output feedback of a phase wave.

17. The smart glasses according to claim 16, wherein the sampling control unit stores the acquired ambient noise in a memory.

18. The smart glasses according to claim 17, wherein the memory is a buffer.

19. The smart glasses according to claim 16, wherein the sampling control unit samples and outputs the ambient noise through a microphone.

20. The smart glasses according to claim 16, further comprising a channel mode switching unit for switching the streaming channel to a standby mode after the ambient noise is transmitted to the head unit.

21. A noise removal method of smart glasses, the method comprising steps of:
(a) receiving a noise request signal from a head unit by a noise request reception unit;
(b) periodically acquiring ambient noise based on the noise request signal by an ambient noise acquisition unit;
(c) storing the acquired ambient noise, and sampling and outputting the stored ambient noise by a sampling control unit; and
(d) transmitting the sampled ambient noise via an open Bluetooth hands-free streaming channel from an ambient noise transmission unit to the head unit to allow the ambient noise to offset noise through output feedback of a phase wave.

22. The noise removal method according to claim 21, wherein the step (c) comprises storing the acquired ambient noise in a memory under control of the sampling control unit.

23. The noise removal method according to claim 22, wherein the step (c) comprises storing the ambient noise in a buffer of the memory under control of the sampling control unit.

24. The noise removal method according to claim 21, wherein the step (c) comprises sampling and outputting the ambient noise through a microphone under control of the sampling control unit.

25. The noise removal method according to claim 22, further comprising (e) switching the streaming channel to a standby mode by a channel mode switching unit after the ambient noise is transmitted to the head unit.

26. A computer-readable recording medium having recorded thereon a computer program for executing the noise removal method according to claim 21.
